(19) United States
(12) Patent Application Publication
(10) Pub. No.: US 2013/0108179 A1
(43) Pub. Date: May 2, 2013

(54) PERSONALIZED PHOTO CALENDAR GENERATION SYSTEM AND METHOD

(71) Applicants: Luca Marchesotti, Grenoble (FR); Julianna Elizabeth Lin, Rochester, NY (US)

(72) Inventors: Luca Marchesotti, Grenoble (FR); Julianna Elizabeth Lin, Rochester, NY (US)

(73) Assignee: Xerox Corporation, Norwalk, CT (US)

(21) Appl. No.: 13/281,774

(22) Filed: Oct. 26, 2011

(51) Int. Cl. G06K 9/62

(52) U.S. Cl. 382/224

(57) ABSTRACT

A method for generating a personalized photo calendar includes providing a mapping between each of a plurality of discrete calendar time periods, such as months, and a set of seasonal themes, such as spring, summer, autumn, and winter. An image signature is computed for each of a set of user images. Scores are computed for the user images with respect to the seasonal themes, based on their computed signatures, with a categorizer trained on training images labeled with the seasonal themes. An image from the set is selected for each of the discrete calendar time periods, based on the mapping and on the computed scores. The selected images are inserted into a calendar template. The automated selection of images can reduce the time spent by a user in selecting images for a calendar, by automatically providing a set of seasonally appropriate images for the template.

### BACKGROUND

The exemplary embodiment relates to the image processing arts. It finds particular application in connection with a system and method for generating a personalized photo calendar.

When designing personalized photo calendars, users are faced with the task of searching through their personal photograph collections to find an appropriate photograph for each month. However, since users can often have hundreds or thousands of unsorted and untagged photographs, this step can become a very lengthy and time-consuming process, leading to frustration and pre-mature abandonment of the project.

While standard image processing techniques can be used to reduce the number of candidate photographs automatically, based on basic image quality characteristics, such as image resolution, contrast, blur, and the like, this does not address the problem of selecting relevant images. For example, an aesthetically pleasing picture of a houseplant is not necessarily an appropriate choice for illustrating the month of February, even if the photograph was captured during February. In general, users would prefer to have a photograph which better reflects the month of February, in some way.

Relying on a photograph's date and time information to infer relevance is not always reliable. This information may be wrong (e.g., if the camera's date and time was set incorrectly or if the camera is in the wrong time zone) or missing (e.g., if the image was obtained second-hand through some other source). The information may also be irrelevant (e.g., as in the case of pictures of houseplants).

The exemplary embodiment provides a system and method for automatically identifying the seasonal relevance of an image, independent of its associated date and time information, which allows the image selection process for photo calendar applications to be at least partially automated.

### INCORPORATION BY REFERENCE

The following references, the disclosures of which are incorporated herein in their entireties, by reference, are mentioned.

Methods for creation of calendars are described, for example in U.S. Pub. No. 20080162303, published Jul. 3, 2008, entitled VARIABLE MONTH CROSS-PLATFORM PHOTO CALENDAR BUILDER, by Ryan Moore, et al., U.S. Pub. No. 20030182210, published Sep. 25, 2003, entitled PRODUCING AND SHARING PERSONALIZED PHOTO CALENDAR, by Erik Weitzman, et al., and U.S. Pub. No. 20110167353, published Jul. 7, 2011, entitled SYSTEM AND METHODS FOR CREATING AND EDITING PHOTO-BASED PROJECTS ON A DIGITAL NETWORK, by Aryk Grosz, et al.

U.S. application Ser. No. 13/111,060, filed on May 19, 2011, entitled TECHNIQUES TO ENABLE AUTOMATED WORKFLOWS FOR THE CREATION OF USER-CUSTOMIZED PHOTOBOOKS, by Craig Saunders, et al., discloses a system and method for generating a photobook. Images are automatically selected as candidates for inclusion in a photobook. A design element of a design template for the photobook is automatically selected, based on information extracted from at least one of the selected images. Placeholders of the design template are automatically filled with images drawn from the subset to form at least one page of a multipage photobook.

Methods for image quality assessment are disclosed, for example, in U.S. application Ser. No. 13/089,460, filed on Apr. 19, 2011, entitled IMAGE QUALITY ASSESSMENT, by Luca Marchesotti, et al.

U.S. Pub. No. 20090232409 published Sep. 17, 2009, entitled AUTOMATIC GENERATION OF A PHOTO GUIDE, by Luca Marchesotti, et al., discloses an automated method for generating a photo guide.

### BRIEF DESCRIPTION

In one aspect of the exemplary embodiment, a method for generating a personalized photo calendar includes providing a mapping between each of a plurality of discrete calendar time periods and a set of seasonal themes. An image signature is computed for each of a set of user images. Scores are computed for the user images with respect to the seasonal themes, based on their computed signatures, with a categorizer which has been trained on training images labeled with the seasonal themes. An image from the set is selected for each of the discrete calendar time periods, based on the mapping and on the computed scores. The selected images are inserted into a calendar template.

In another aspect, a system for generating a personalized photo calendar includes memory which stores a mapping between each of a plurality of discrete calendar time periods and a set of seasonal themes, a signature generator for computing an image signature for each of a set of user images, a seasonal categorizer for categorizing the user images in the set with respect to the seasonal themes, a selection component for selecting an image for each of the discrete calendar time periods, based on the mapping and on the categorizing, and a representation component for generating a representation of the selected images inserted into a calendar template. A processor is in communication with the memory for implementing the signature generator, seasonal categorizer, selection component, and representation component.

In another aspect, a method for generating a personalized photo calendar includes receiving a set of user images. A probabilistic mapping between months of the year and a set of seasonal themes, a categorizer which includes a set of models, one of each of the seasonal themes, each of the models having been trained on image signatures of training images labeled with the seasonal themes, and a calendar template are stored in memory. The method further includes computing an image signature for each of the set of user images, categorizing the user images with respect to the seasonal themes, based on their computed signatures, with the categorizer models, and selecting an image for each of the months, based on the mapping and on the categorizing. The selected images are inserted into the calendar template. The calendar template with the inserted images is output to be validated by a user. Provision is made for updating the categorizer models based on images validated for a calendar template by one or more users.

### BRIEF DESCRIPTION OF THE DRAWINGS

FIG. 1 is a functional block diagram of an environment in which a calendar generation system operates;

FIG. 2 illustrates part of an exemplary calendar template to be filled with thematic images;

FIG. 3 is a flow chart illustrating a method for generating a calendar in accordance with another aspect of the exemplary embodiment;

FIG. 4 illustrates an exemplary matrix which maps months to a set of discrete seasons;

FIG. 5 illustrates an exemplary matrix which maps images to the set of discrete seasons; and

FIG. 6 illustrates an automatically filled set of templates in which a user has indicated that three of the images should be replaced.

### DETAILED DESCRIPTION

Aspects of the exemplary embodiment relate to a system and method for assisting users in the selection of seasonally appropriate images for a photo calendar application. The system includes a categorizer which is adapted to score a pool of images automatically, based on a finite set of seasonal themes. The exemplary images are the user's images, allowing the photo calendar to be personalized for the user. The themes may be seasons of the year, such as spring, summer, autumn, and winter, or months of the year, such as the twelve months January, February, etc. The scores of the images are used to identify a subset of the images that are auto-flowed into a calendar template, which may be presented to the user for review. The exemplary system may also suggest alternative images from the remaining pool of images, or from images retrieved from third-party image repositories, in the event that the user is not satisfied with one or more of the automatically selected images. The exemplary categorizer includes one or more classification models which learn the themes (e.g., seasons, months, etc.) within the context of a photo-calendar application.

An automated workflow for selecting and autoflowing thematically-appropriate images into a photo-calendar template, using automatically tagged images, is also provided. In the workflow, the images to be autoflowed can be selected from the user's personal database of images, a third-party image repository, or a combination of the two sources. For example, the images can be selected from a specific set of, for example, twelve images provided directly by the user, from a larger set of images from the user's private image database, from third-party repositories (such as the Flickr™ or Photobucket™ databases), or a combination of any of these sources.

A user, in this context, can be any person or persons having access to a source of images.

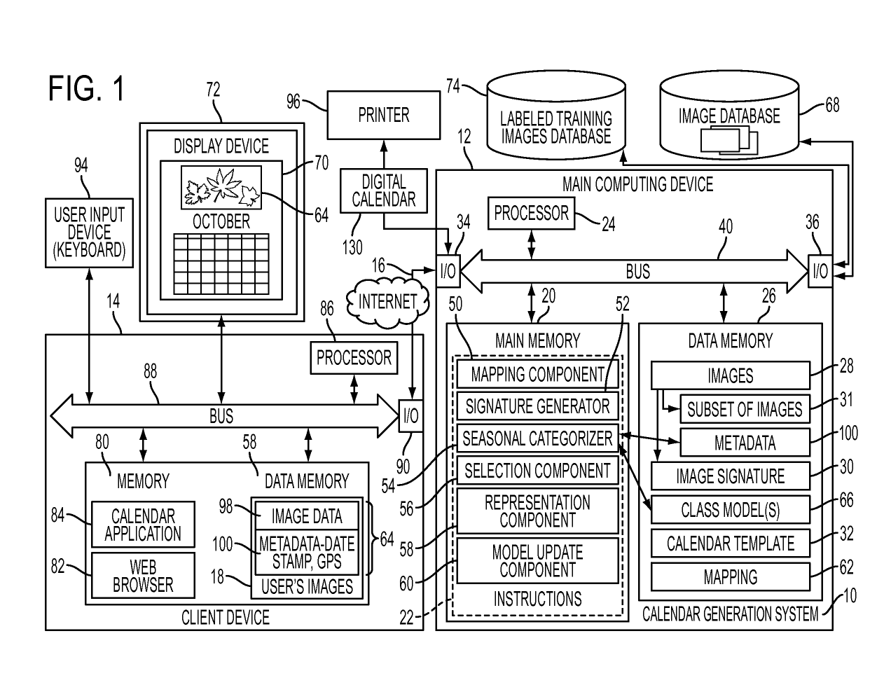

With reference to FIG. 1, an environment in which an exemplary photo calendar generation system 10 operates is shown. The system 10, which may be implemented in one or more computing devices 12, communicates with a plurality of independently operated client devices 14, remote from the computer 12, via a link 16. The client devices 14 can be any device capable of storing or accessing a collection 18 of user images. For example, the system 10 communicates with device 14 via one or more wired or wireless links 16, such as a telephone line, local area network or wide area network, such as the Internet, or a combination thereof.

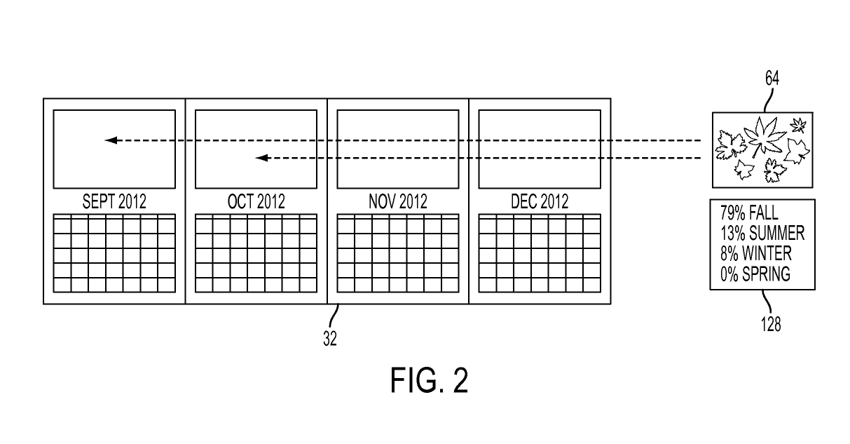

The exemplary system 10 includes main memory 20 which stores instructions 22 for performing the exemplary method and a processor 24, in communication with the memory 20, for executing the instructions. Data memory 26 is configured for receiving and storing a set 28 of the user images 18 and/or content-based representations (image signatures) 30 of these images. The exemplary system 10 is configured for flowing an automatically selected subset 31 of images comprising a predefined number (e.g., twelve) of the set of images 28 from the user's collection 18 into a calendar template 32 (FIG. 2). The template 32 may be stored in memory 26, e.g., as a set of pages from which a twelve month set of pages can be assembled, or as instructions for computing the pages based on calendar information. The system 10 includes one or more network interfaces 34, 36 for interacting with other devices via the network 16. Hardware components 20, 24, 26, 34, 36 of the system 10 are communicatively connected via a data/control bus 40.

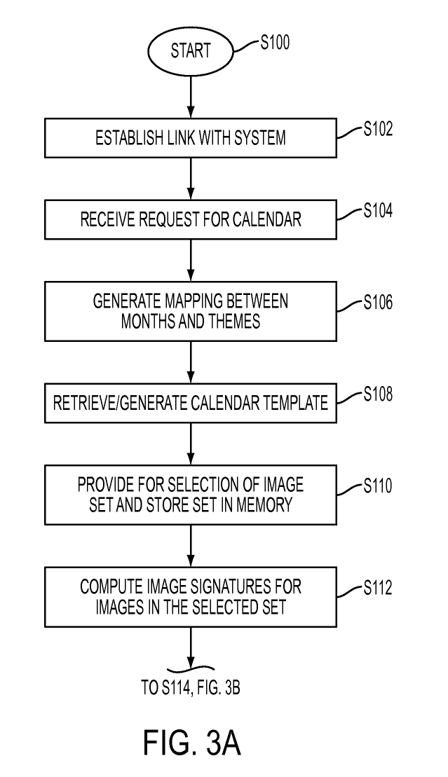

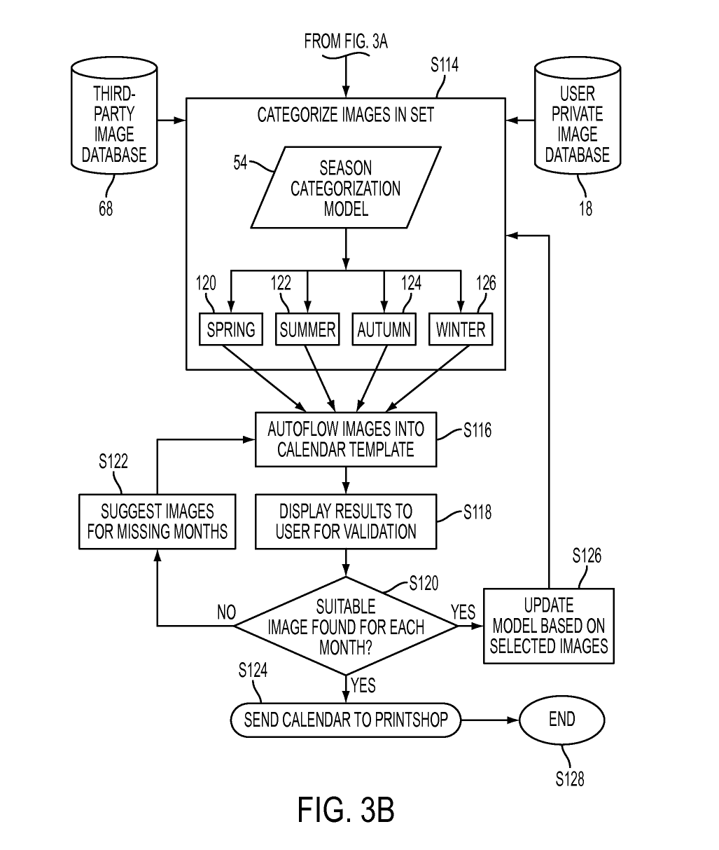

The system 10 includes various components for performing the exemplary method, including a mapping component 50, a signature generator 52, a categorizer 54, an image selection component 56, a representation component 58, and a model update component 60, which will best be understood with reference to the exemplary method described below with reference to FIG. 3. The exemplary components 50, 52, 54, 56, 58, 60 are in the form of software executed by the processor 24, although in other embodiments, one or more of components may be in the form of hardware.

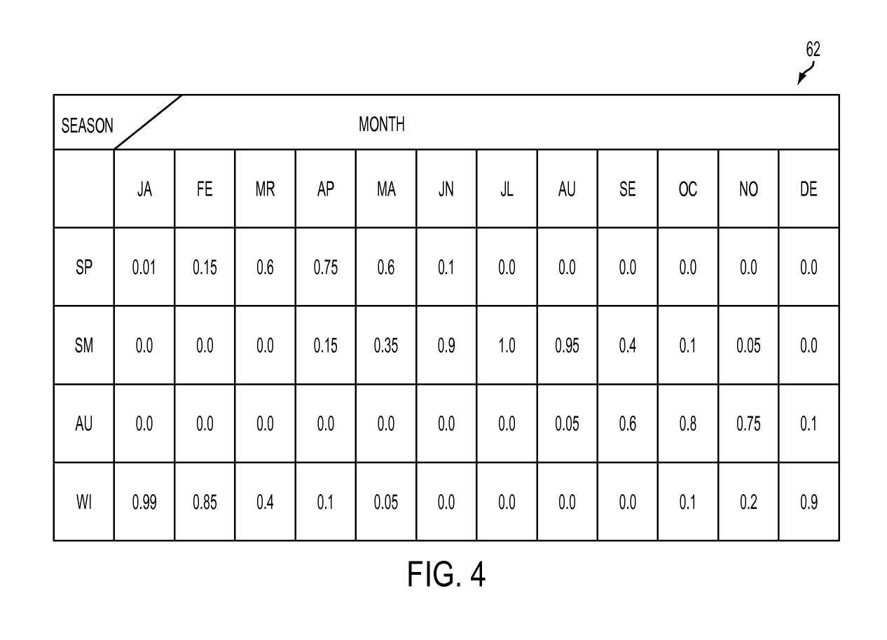

Briefly, the mapping component 50 generates a mapping 62 (see, e.g., FIG. 4) between a finite set of discrete calendar time periods (e.g., months) and a finite set of discrete themes (e.g., spring, summer, fall, winter), which generally relate to times of the calendar year. In this embodiment, the time periods are probabilistically assigned over the themes. In other embodiments, each month is assigned to exactly one theme. The mapping 62 may be based on user input and/or location information from which the months can be appropriately mapped to the seasons. Each of a plurality of geographical regions may be associated with a respective mapping 62.

The signature generator 52 is configured for generating an image signature 30 of an image, such as a user image 64 in set 28, based on features extracted from the image. The categorizer 54 scores the user images based on their extracted signatures 30, using one or more trained classifier models 66, for example, one classifier model for each theme and/or subtheme. The image selection component 56 selects a subset 31 of the images from set 28 and assigns each of the images to a respective month in the calendar, based on the category scores output by the categorizer 54 and the mapping 62. The selection component 56 may also receive user inputs which cause the system 10 to select alternative images/arrangements of images to those automatically selected, e.g., from the set 28, or the user's entire collection of images 18, or from a commercial collection 68 of images, e.g., stored in an image database on a remote server. Such images may be accessed on a photosharing website, such as the Flickr® website. The representation component 58 generates a graphical representation 70 of the filled calendar template for display to the user, e.g., on a display device 72 associated with the client device 14. The model update component 60 updates the class model(s) 66, based on the user selections for the calendar.

The system 10 has access to a training set 74 of images for initial training of the class models 66. The training images are each labeled with a respective class, each class label corresponding to a respective theme and/or subtheme (such as from the themes Spring, Summer, Fall, Winter, or from the subthemes Spring—March, Spring—April, etc.). The training images 74 are used by the categorizer 54 to learn the class model(s) 66, during the training stage, one class model for each theme. The training images 74 may be stored in local memory, such as memory 26, or accessed from a remote memory storage device. For each training image, an image signature 30 is computed, as for the user images. The image signatures, together with the respective class labels, are then input to the models 66. In some embodiments, the training images 74 may be at least partly drawn from the collection 18.

A user operating a respective client device 14 can interact with the system, review the filled calendar template 70, and accept and/or modify it. For example the client device 14 includes memory 80 which stores a web browser 82 for accessing a web portal for the system 10 and a calendar application 84 which uploads user images to the system. For example, the calendar application 84 can be in the form of an application software package downloaded using the web browser 82 on the client device, e.g., provided by the system 10. The collection of user images 18 may also be stored in memory 80 on the client device 12 or may be accessed from external memory, for example, by uploading the images to a server computer accessible to the system 10. The server computer may, in turn, upload the images, or their computed image signatures, to the system 10. A processor 86, which implements the calendar application 84 and web browser 82, may be communicatively linked to memory 80 by a system bus 88. A network interface 90 links the client device 14 to external devices, e.g., via network 16.

An output device, such as display device 72 (e.g., an LCD screen or a computer monitor), is linked to the processor 86 and memory 80, e.g., via the system bus 88. The display device 72 presents the representation 70 of the filled calendar template to the user in visual form, e.g., as a set of pages, one for each month, with an image 64 assigned to each page. In general, each page (month) has no less than one image assigned to it and in some embodiments, provision may be made for one or more of the pages to include more than one image 64 for a respective month, such as two three, or four images, e.g., up to a predetermined maximum number of images. Where more than one image per calendar page is permitted, the system 10 may store a set of image layout templates. Each of the templates may accept a set of images in a predetermined arrangement on the page, according to the respective layout template.

The display device 72 provides the user with a graphical user interface to view, edit, and prepare a print order for the calendar and an associated data file, using the subset 31 of digitally represented images 64 and template 32. A user input device(s) 94, such as a keypad, keyboard, cursor control device, touch screen, or the like, connected to bus 88, is provided for a user to input commands and information to the client computer 14, such as for rejection of one (or more) of the assigned images 64 and selection of the image set 28, and to interact with application 84. Other peripheral devices may be connected to client computer 14, e.g., through interface 90, to transfer information to and from the client computer. For example, a camera may be connected so that data representative of photographic images may be downloaded to memory 80 or another memory storage device associated with computer 14 and/or 12 so that the images may be subsequently printed on a calendar by a photofinisher 96, e.g., with a printer.

The exemplary digital images 64 in the user's collection 18 are photographic images, such as individual photographic images (photos), video images (videos), and combinations thereof which may be multicolor (color) and/or monochrome (e.g., black and white) images. The images 64 may be stored in any convenient file format, such as JPEG, TIFF, PNG, or the like. Each image includes information including image data 98 for forming an array of pixels which can be used to form an output image when rendered on an output device, such as a display device, printer, or the like. The image data 98 may include colorant values, such as grayscale values, for each of a set of color separations, such as RGB, or be expressed in another color space in which different colors can be represented. In general, “grayscale” refers to the optical density value of any single color channel, however expressed (RGB, YCbCr, etc.). Digital images may also have associated information 100 in addition to the image data, which may be in the form of metadata, such as that included in exchangeable image file format (EXIF) data in the case of image files from cameras, smartphones and scanners. The associated information 100, may be generated by an image capture device, such as a camera, and may include at least one of a time stamp (a record of the day and/or time at which the image was captured) and geo-positional (GPS) information (e.g., which represents the latitude and longitude, to several decimal places, of the respective image capture device at the time of image capture). During processing by the system, a digital image 64 may be cropped, have its pixel resolution changed (e.g., reduced), be color modified, processed to reduce blur or increase sharpness, be converted to another file format, or otherwise processed, the resulting image still being referred to herein as the “image.”

The system 10 is hosted by one or more main computing devices, such as the illustrated server computer 12. The client device 14 may be a personal computer, such as a desktop, laptop, pad, notebook, or palmtop computer, or portable digital assistant (PDA), smartphone, or the like. As will be appreciated, while the exemplary method is implemented in a plurality of computing devices 12, 14, in some embodiments, all of the instructions 84, 22 may be stored in the client device 14 itself, or are otherwise distributed over the computing devices 12, 14.

The digital processors 24, 86 can each be variously embodied, such as by a single-core processor, a dual-core processor (or more generally by a multiple-core processor), a digital processor and cooperating math coprocessor, a digital controller, or the like. In general, any device, capable of implementing a finite state machine that is in turn capable of implementing the flowchart shown in FIG. 3, can be used as the processor. The memory or memories 20, 26, and 80 may each represent any type of non-transitory computer readable medium, such as random access memory (RAM), read only memory (ROM), magnetic disk or tape, optical disk, flash memory, or holographic memory. In one embodiment, the memory 20, 26 (and similarly memory 80) comprises a combination of random access memory and read only memory. Exemplary memory 20, 26, 80 stores instructions for performing the exemplary method and data used and generated therein, which may be transferred or shared between memories, as described in greater detail below. The exemplary arrangement of computing devices is intended to be illustrative only.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

With reference also to FIG. 3, a flow chart illustrating a computer implemented method for generating a calendar is shown. The method begins at S100.

At S102, a communication link may be established between the client device 14 and server computer 12. For example, a web portal is provided for receiving images 28 uploaded by client device 14 and for transmitting a calendar application 84 to the client device.

At S104, using the interface displayed on the display device 72, the user selects to generate a calendar and the calendar generation request is uploaded to the server computer 12 and received by the system 10.

At S106, a mapping 62 is generated between the months (at least those months to be covered by the calendar) and a set of themes, which is appropriate to the user's geographical location. The mapping 62 for the location may have been previously generated and stored in memory, optionally together with a mapping for one or more other geographical locations, in which case, the pre-generated mapping is retrieved.

At S108, a calendar template 32 for the selected months is generated/retrieved.

At S110, the system 10 prompts the user to select a set of images, such as a subset 28 of the images in the user's collection 18 (which may have already been uploaded to the website offering the calendar making service. The system receives the set of images 28 or their identifiers.

At S112, image signatures 30 are computed, by the signature generator 52, for the images in the set 28 (or previously generated image signatures for these images are retrieved).

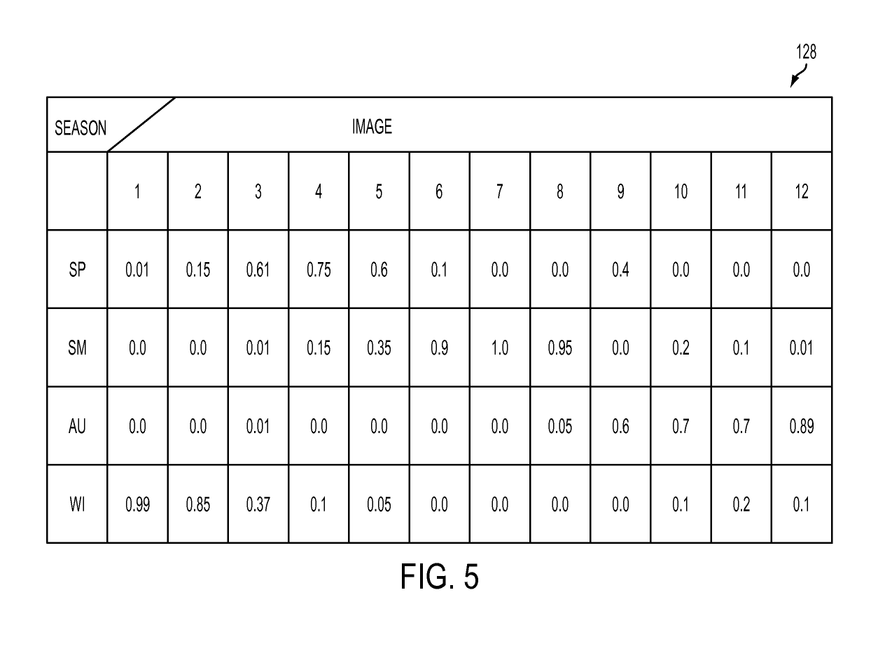

At S114, the images in the set are categorized based on their computed image signatures 30, by the seasonal categorizer 54 using one or more seasonal class models 66. In particular, the categorization model outputs a subset of the image 28 for each of the themes, such as the illustrated subsets 120, 122, 124, 126. The images may be scored with a scoring 128, which is based on the responsiveness to the particular theme (see, e.g., FIG. 5).

At S116, the images are autoflowed into the template based on the categorizer scores 128 and the mapping 62. This includes selecting an image for each of the discrete calendar time periods (months), based on the mapping between the discrete calendar time periods and the seasonal themes and on the scores computed at S114. The selected images are inserted into the calendar template.

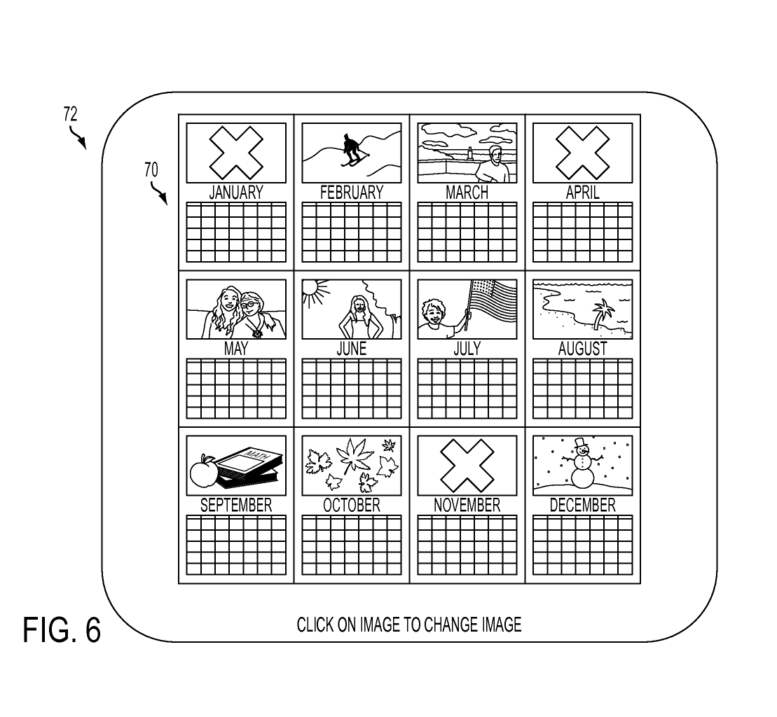

At S118, the suggested image autoflow is displayed to the user for validation, e.g., as a filled calendar template 70 (FIG. 6). For example, the filled calendar template (or a simplified representation thereof showing at least the month information and a thumbnail of the assigned image) is displayed to the user using display device 72, for validation. The selected subset 31 of images and their order in the template is validated by the user, who can de-select the images that the user does not like for one or more of the months. This can be done by clicking over the images in the user interface, as illustrated, for example, by the X's displayed in the representation 70 shown in FIG. 6.

If, at S120, one or more of the images is found to be unsuitable, the method proceeds to S122, where additional images may be suggested, e.g., from the appropriate seasonal set 120, 122, 124, 126, if there are any more images remaining, or images from the third party image database 68, which have been categorized by the seasonal categorizer 54. The method returns to S116, where the replacement images are autoflowed into the template 32, based on the mapping 62 between the seasons and the months. For example, in the case of the filled template 70 represented on the user interface, as shown in FIG. 6, the system automatically retrieves alternative images for the three months (January, April, November) for which the user has rejected the automatically assigned image.

If at S120, the user has accepted the set of images which have been automatically selected for filling the calendar template 32, and optionally performed one or more operations for the images, such as adding textual comments and/or cropping the image(s), the method proceeds to S124, where the completed digital calendar 130 is sent to the printshop 96 (FIG. 1).

At S126, the seasonal class models 66 may be updated, based on the user's selections at S118.

The method ends at S128.

The method illustrated in FIG. 3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3, can be used to implement the exemplary method.

Further details of the system and method are now provided.

### High-level Image Categorization

When creating a personalized print artifact, users typically search through their personal photograph collections to find photographs that match the desired theme(s) of their printed item. In the specific case of a photo-calendar, users typically look for images that comply with a particular monthly or seasonal theme. In the exemplary embodiment, it has been found that four broad themes (corresponding to the four seasons) can be selected and modeled using machine learning techniques. This is unexpected, since the visual concepts associated to seasonal concepts such as winter, spring, summer, or autumn are highly subjective. Moreover, seasons are different at different latitudes, affecting weather, vegetation, human habits, etc. However, a learning approach based solely on visual information has proved to be successful in interpreting the “seasonal” theme of an image, when tested on a large collection of images (such as the database provided for the ImageCLEF Photo Retrieval Task 2009). From a review of the results of the exemplary categorizer 54 using four seasonal class models 66 on this dataset, the semantic (and visual) coherence among the images assigned to the same seasonal class are recognizable.

1. Computation of Image Signatures (S112)

The images 64 are each represented by a signature 30, such as a multidimensional vector, graph, or the like, which is a statistical representation of visual features extracted from the image. While a variety of vectorial image representations are contemplated as image signatures, in the exemplary embodiment, the signatures model the distribution of feature sets using fixed-length vectorial representations. The method includes computing for each of one or more low-level local feature types, a set of statistics. These statistics can then be aggregated into an image-level representation or “signature.” While the signature may carry less information than the original image, in general, sufficient information is included to provide each different image 64 in the user's set with a unique signature.

Fisher vectors, Fisher Kernel representations, and Bag-of-Visual-Word representations are exemplary of such types of high-level statistical representation which can be used herein as an image signature 30.

For example, the signature generator 52 includes a patch extractor, which extracts and analyzes low level visual features of patches of the image, such as shape, texture, or color features, or the like. The patches can be obtained by image segmentation, by applying specific interest point detectors, by considering a regular grid, or simply by the random sampling of image patches. The extracted low level features (such as vectors or histograms) from each patch can be concatenated and optionally reduced in dimensionality, to form a features vector which serves as the image signature. In other approaches, the feature vectors of the patches of an image are assigned to clusters. For example, a visual vocabulary is previously obtained by clustering low-level features extracted from training images, using for instance K-means clustering analysis. Each patch vector is then assigned to a nearest cluster and a histogram of the assignments can be generated. In other approaches, a probabilistic framework is employed. For example, it is assumed that there exists an underlying generative model, such as a Gaussian Mixture Model (GMM), from which all the patch vectors are emitted. Each patch can thus be characterized by a vector of weights, one weight for each of the Gassian functions forming the mixture model. In this case, the visual vocabulary can be estimated using the Expectation-Maximization (EM) algorithm. In either case, each visual word in the vocabulary corresponds to a grouping of typical low-level features. The visual words may each correspond (approximately) to a mid-level image feature such as a type of visual (rather than digital) object (e.g., ball or sphere, rod or shaft, flower, autumn leaves, etc.), characteristic background (e.g., starlit sky, blue sky, grass field, snow, beach, etc.), or the like. Given a new image 64 in set 28 to be assigned a signature 30, each extracted feature vector is assigned to its closest visual word in the previously trained vocabulary or to all visual words in a probabilistic manner in the case of a stochastic model. A histogram is computed by accumulating the occurrences of each visual word. The histogram can serve as the image signature 30 or input to a generative model which outputs an image signature 30 based thereon.

For example, as the patch feature vectors, local descriptors extracted from the patches, such as SIFT descriptors or other gradient-based feature descriptors, can be used. See, e.g., Lowe, “Distinctive image features from scale-invariant keypoints,” IJCV vol. 60 (2004). In one illustrative example employing SIFT features, the features are extracted from 32×32 pixel patches on regular grids (every 16 pixels) at five scales, using 128-D SIFT descriptors. Other suitable local descriptors which can be extracted include simple 96-D color features in which a patch is subdivided into 4×4 sub-regions and in each sub-region the mean and standard deviation are computed for the three channels (R, G and B). These are merely illustrative examples, and additional and/or other features can be used. The number of features is optionally reduced, e.g., to 64 dimensions, using Principal Component Analysis (PCA). Signatures can be computed for two or more regions of the image and aggregated, e.g., concatenated.

For example, any of the methods disclosed in the following references, the disclosures of which are incorporated herein by reference in their entireties, can be used for generating an image signature 30, based on visual content: U.S. Pub. Nos. 20030021481; 2007005356; 20070258648; 20080069456; 20080240572; 20080317358; 20090144033; 20100040285; 20100092084; 20100098343; 20100191743; 20100189354; 20100318477; 20110040711; 20110026831; 20110052063; 20110091105; U.S. application Ser. No. 12/693,795, filed on Jan. 26, 2010, entitled A SYSTEM FOR CREATIVE IMAGE NAVIGATION AND EXPLORATION, by Sandra Skaff, et al.; U.S. application Ser. No. 12/859,898, filed on Aug. 20, 2010, entitled LARGE SCALE IMAGE CLASSIFICATION, by Florent Perronnin, et al.; U.S. application Ser. No. 12/890,789, filed on Sep. 27 2010, entitled IMAGE CLASSIFICATION EMPLOYING IMAGE VECTORS COMPRESSED USING VECTOR QUANTIZATION, by Jorge Sánchez, et al., Gabriela Csurka, et al., “Visual Categorization with Bags of Keypoints,” European Conf. on Computer Vision (ECCV) Workshop on Statistical Learning in Computer Vision (2004); Perronnin, F., Dance, C., Csurka, G., and Bressan, M., “Adapted Vocabularies for Generic Visual Categorization,” in ECCV 2006; Florent Perronnin, et al., Perronnin, F., Dance, C., “Fisher Kernels on Visual Vocabularies for Image Categorization,” in Proc. IEEE Conf on Computer Vision and Pattern Recognition (CVPR), Minneapolis, Minn., USA (June 2007); Yan-Tao Zheng, Ming Zhao, Yang Song, H. Adam, U. Buddemeier, A. Bissacco, F. Brucher, Tat-Seng Chua, and H. Neven, “Tour the World: Building a web-scale landmark recognition engine,” IEEE Computer Society Conference (2009); Herve Jegou, Matthijs Douze, and Cordelia Schmid, “Improving Bag-Of-Features for Large Scale Image Search,” in IJCV, 2010; F. Perronnin, J. Sánchez, and T. Mensink, “Improving the Fisher kernel for large-scale image classification,” in ECCV 2010; Florent Perronnin, et al., “Large-scale image categorization with explicit data embedding,” in CVPR 2010; and Jorge Sánchez and Florent Perronnin, “High-dimensional signature compression for large-scale image classification,” in CVPR 2011.

In some illustrative examples, a Fisher vector is computed for the image (or each of a set of two or more regions of the image) by modeling the extracted local descriptors of the image/region using a mixture model to generate a corresponding image/region vector having vector elements that are indicative of parameters of mixture model components of the mixture model representing the extracted local descriptors of the image region. The exemplary mixture model is a Gaussian mixture model (GMM) comprising a set of Gaussian functions (Gaussians) to which weights are assigned in the parameter training. Each Gaussian is represented by its mean vector, and covariance matrix. It can be assumed that the covariance matrices are diagonal. See, e.g., Perronnin et al., “Fisher kernels on visual vocabularies for image categorization” in CVPR (2007). Where Fisher vectors are computed for image regions, these can be concatenated to form the final image vector representing the image. Methods for computing Fisher vectors are more fully described in above-mentioned application Ser. No. 12/890,789 and Sánchez, et al., CVPR 2011. The trained GMM is intended to describe the content of any image within a range of interest (for example, any color photograph if the range of interest is color photographs).

2. Training of the Class Models(s)

The exemplary categorizer 54 employs one or more classifier models 66, such as one or more binary classifiers, which has/have been trained on a training set 74 of image signatures and their labels (supervised learning). Each training set for a given seasonal theme or other theme may include a first set of signatures, which are assigned positive labels, and a second set of image signatures, e.g., randomly drawn from the database 72, as the negatively labeled signatures. Typically, each class model 66 has adjustable parameters whose values are determined by training on the labeled training set. The objective of the training is to select the adjustable parameters such that the output of the classifier model 66 substantially agrees with the classification labels assigned to the training set signatures. The exemplary classifier model(s) 66 may be linear or nonlinear, and use any suitable classification training algorithm, such as sparse logistic regression, naïve Bayes, linear discriminant analysis, support vector machines, linear regression, or any other suitable machine learning method.

In one embodiment, to provide the training data 74 for the classifier models 64, the system 10 may crawl the database 68 to find a subset of images in the database which have each been tagged with a category (or categories) of interest, i.e., corresponding to one the themes. These serve as positive examples, with negative samples optionally being drawn randomly from the rest of the database 68. In another embodiment, the labeled training samples for each class may be manually selected, e.g., by the system's owner or user, who may also provide the negative samples.

In the model enrichment step (S126), all the images that were selected and validated by the user are used to update the categorizer class models 66.

Categorization (S112)

The trained classifier models 66 are able to assign a score based on how well an image signature 30 matches the model. An exemplary categorizer of this type which may be used herein is the Xerox Generic Visual Classifier (GVC) as described, for example, in U.S. Pub. Nos. 2007/0005356, 2007/0258648, and 2008/0069456, the disclosures of which are incorporated herein by reference in their entireties.

The categorizer 54 inputs the signature to each of the pretrained set of binary class models 66 or to a single multi-class classifier model. In one embodiment, at S112, the categorizer 54 assigns a single one of the predefined set of themes to each of the user images 64, based on its signature 30. For example, the trained class models 66 may each assign a score based on how well an image signature of the image matches the model, and the categorizer outputs a theme corresponding to the highest score. In other embodiments, for example, the categorizer 54 may assign each image probabilistically over all themes, based on its computed image signature (as exemplified in the scoring matrix shown in FIG. 5). In this case, in the autoflow process, the selection component 56 may employ an optimization function which selects an optimal assignment of the set of images as a whole to the calendar months, based on the probabilities in the scoring matrix 128 and the mapping matrix 62, as described below.

The categorizer may assign the seasonal theme with the highest score to the image or use other information 100, in addition to the class scores, such as GPS information, date stamps, or the like in computing the most probable category.

Image Auto-Flow (S116)

Various strategies that can be used to autoflow images into a calendar template 32 (like the one illustrated in FIG. 2) are contemplated. A simple one includes placing images that received the highest categorization scores on to the appropriate placeholders. An additional constraint is to select different images for different months.

One proposed solution is to apply an optimization routine, which can be formalized as follows:

In this embodiment, the mapping 62 (S106) is assumed to be probabilistic, such that some months may have a high probability of being in a particular theme while for others, there may be a significant probability of the month being in two themes. For example, a binary matrix 62 may be defined as P(m, s), which indicates the association between month m and season s as a probability (note that Σₛ P(m, s)=1). Such a mapping matrix 62 can be tailored to “localize” the calendar. As will be appreciated, summer months in the southern hemisphere, such as in Argentina, do not correspond to summer months in the northern hemisphere, such as in the USA or France. Also, the months that are in summer may be shorter or longer with latitude. An example matrix is illustrated in FIG. 4, for the Midwest USA region. For example the month of July has been assigned the maximum probability of 1 of being in “summer,” while September has a probability of 0.4 of being in summer and a probability 0.6 of being in fall. In other embodiments, each month is mapped to exactly one theme.

In general, the mapping involves a many to one mapping since there is a greater number of discrete calendar time periods than the number of seasonal themes.

A scoring matrix I(s,i) 128 can be defined where each row contains the score of the images with respect to each season s (which can be a numerical ranking, or simply a score, such as from 0-1 inclusive). The scoring is based on the classification scores assigned by the models of the seasonal categorizer 54.

The optimization routine computes A(m, i)=P(m, s)·I(s, i) to obtain a ranking (which can be a numerical ranking or simply a score) for each individual month for each image in the set 28.

Then, to each month in the template 32, the (remaining) image in the set 28 with the highest rank for that month is assigned, which has not already been assigned to a preceding month. In one embodiment, for each season in turn, an image is selected in this way for the month which is ranked highest with respect to that season (January, April, July, October, in FIG. 4). After selecting images for each of these four months, the method returns to the first season, where an image is selected for the next most highly ranked month (e.g., December, March, August, November), and so forth through the seasons, until all the months are covered.

More elaborate strategies for maximizing the pertinence of images subjected to dissimilarity are contemplated as a means of increasing the diversity of images in the final product. For example, three images of snowmen may receive the highest rankings for “winter,” but the user is likely to prefer images of different subjects for the three winter months. Thus, an additional constraint may be placed on the selection which takes into account the dissimilarity of images as well as their rankings. For example, if one image from a cluster of similar images is used, then the system aims to choose none of the others from that cluster for the rest of the calendar (which may be modified if the user specifically wants that result).

In some embodiments, additional information may also be used in the ranking of images, such as the image metadata 100. Metadata may also be used is to identify particular events that the user associates with particular months; e.g., special holidays (Halloween, Valentine's Day, . . . ), local festivals (e.g. lilac festival, neighborhood festivals, . . . ), or birthdays, wedding anniversaries, etc.

### User Validation (S118)

A preview 70 of the calendar is shown to the user for final validation. A screenshot of an exemplary visualization is shown in FIG. 6.

The user is provided with the opportunity to discard one or more of the images. For example, the user may discard images that are not appealing to the user or that the user feels do not embody the desired concept (season).

### Automatic Suggestion of Replacement Images (S122)

In the event that the user is not satisfied with the results of the image selection and auto-flow process, the exemplary system 10 is capable of suggesting alternatives for the unsatisfactory images.

This situation might occur for a variety of reasons, including: a) the classification model 66 did not score appropriate images high enough to be selected and flowed into the calendar; b) the user does not own images embodying the desired concept (e.g., the user might not have any pictures that embody “winter”); c) the user simply does not like the suggested image.

In one embodiment, S122 proceeds as follows. First, for all the images that were discarded by the user, the images remaining in the set 28 with the next highest relevance/classification scores for that month can be suggested to the user. In one embodiment, this procedure is only repeated for a limited (e.g., pre-defined) number of times. After that, the system may assume that there are no more thematically-relevant images within the user's photo-collection that can be autoflowed into the specific placeholder. At this time, images from a set of third-party image repositories 68, which have been previously classified by the models 66 may be proposed to the user. Any license fees due for such images, e.g., under a Creative Common terms of use, are paid if the user decides to use one of these images.

### Model Enrichment (S126)

Once the user has validated all of the images in the calendar representation 70, the model(s) 66 used in the high-level categorization step are enriched. For example, in the case that the user has validated the whole calendar, the user's choices can be used to learn a better categorization model 66. In one embodiment, all the selected images are saved along with the corresponding matrices P and I. A new categorization model 66 can be periodically re-trained when the quantity of new images exceeds a particular threshold value.

In other embodiments, where a user has only accepted some of the images, the accepted images are mapped to the corresponding season. For example, an image which the user has accepted as the “March” image is tagged with the highest ranked season to which March is mapped in the mapping 62, or accorded the probabilities for each of the seasons from the mapping.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for generating a personalized photo calendar comprising:
providing a mapping between each of a plurality of discrete calendar time periods and a set of seasonal themes;
computing an image signature for each of a set of user images;
computing scores for the user images with respect to the seasonal themes, based on their computed signatures, with a categorizer which has been trained on training images labeled with the seasonal themes;
selecting an image from the set of images for each of the discrete calendar time periods, based on the mapping and on the computed scores; and
inserting the selected images into a calendar template.

2. The method of claim 1, wherein at least one of the computing image signatures, computing scores for the user images, and the selecting of images is performed with a computer processor.

3. The method of claim 1, wherein the selecting images includes computing scores for the user images, with respect to the discrete calendar time periods based on the scores computed for the user images with respect to the seasonal themes and the mapping.

4. The method of claim 1, wherein the number of discrete calendar time periods is greater than the number of seasonal themes.

5. The method of claim 1, wherein the set of user images comprises more images than the number of discrete calendar time periods.

6. The method of claim 1, wherein the discrete calendar time periods are months.

7. The method of claim 1, wherein the seasonal themes are spring, summer, autumn, and winter.

8. The method of claim 1, further comprising providing a plurality of mappings comprising one mapping for each of a plurality of geographic regions.

9. The method of claim 1, wherein the mapping assigns a probability to each discrete time period for each of the months which range between maximum and minimum values.

10. The method of claim 1, further comprising providing for displaying the template with the selected images to a user for validation.

11. The method of claim 10, further comprising providing for the user to reject at least one of the selected images, and, where an image is rejected, identifying a replacement image from the set of images or from a database of images.

12. The method of claim 1, wherein the categorizing comprises partitioning the images in the set of images into subsets based on the scores, one subset for each of the seasonal themes, and wherein at least one replacement image is drawn from the same subset as the rejected image that it replaces.

13. The method of claim 1, further comprising outputting the template with a set of validated images, the set of validated images comprising ones of the selected images and any images that the user has selected as replacements for others of the set of images.

14. The method of claim 13, further comprising updating the categorizer based on the set of validated images.

15. The method of claim 1, wherein the categorizer includes a class model for each of the seasonal themes which has been trained on a respective set of labeled training images.

16. The method of claim 1, wherein the computing image signatures comprises, for each image, extracting a set of local features from the image, and generating an image signature which describes the distribution of the local features.

17. A computer program product comprising a non-transitory recording medium which stores instructions which when executed by a processor, perform the method of claim 1.

18. A system comprising memory which stores the mapping and instructions for performing the method of claim 1 and a processor in communication with the memory for executing the instructions.

19. A system for generating a personalized photo calendar comprising:
memory which stores:
a mapping between each of a plurality of discrete calendar time periods and a set of seasonal themes;
a signature generator for computing an image signature for each of a set of user images;
a seasonal categorizer for categorizing the user images in the set with respect to the seasonal themes;
a selection component for selecting an image for each of the discrete calendar time periods, based on the mapping and on the categorizing; and
a representation component for generating a representation of the selected images inserted into a calendar template; and
a processor in communication with the memory for implementing the signature generator, seasonal categorizer, selection component, and representation component.

20. The system of claim 19, further comprising an update component which updates a seasonal class model for each of the seasonal themes used by the seasonal categorizer.

21. The system of claim 19, further comprising a mapping component which generates the mapping.

22. The system of claim 19, wherein the system is configured for interacting with a calendar application on a client device.

23. A method for generating a personalized photo calendar comprising:
receiving a set of user images;
storing in memory a probabilistic mapping between months of the year and a set of seasonal themes;
storing in memory a categorizer which includes a set of models, one of each of the seasonal themes, each of the models having been trained on image signatures of training images labeled with the seasonal themes;
storing in memory a calendar template;
computing an image signature for each of the set of user images;
categorizing the user images with respect to the seasonal themes, based on their computed signatures, with the categorizer models;
selecting an image for each of the months, based on the mapping and on the categorizing;
inserting the selected images into a calendar template;
outputting the calendar template with the inserted images to be validated by a user; and
providing for updating the categorizer models based on images validated for a calendar template by one or more users.
